(19) United States
(12) Patent Application Publication
(10) Pub. No.: US 2004/0204664 A1
(43) Pub. Date: Oct. 14, 2004

(54) Massage member for neck

(76) Inventor: Julian Chu, San Chung City (TW)

Correspondence Address: Chang Chia Wei, P.O. Box 25-7, Kaohsiung City 811, TW

(21) Appl. No.: 10/419,916

(22) Filed: Apr. 9, 2003

(51) Int. Cl. A61H 15/00

(52) U.S. Cl. 601/121; 601/134; 601/136

(57) ABSTRACT

A massage member comprises an elongated member having an outer periphery and made of soft material. Two groups of protrusions are formed on the outer periphery of the elongated member and spaced apart by a portion of a length of the elongated member. Each group of protrusions includes a plurality of rows of protrusions. Each row of protrusions is annularly arranged on the outer periphery of the elongated member. In each group of protrusions, each of one row of protrusions has a radial length that is shorter than that each of another row of protrusions that is more far away from the portion of the length of the elongated member. The groups of protrusions together define a neck receiving area for receiving and massaging a neck of a body.

### BACKGROUND OF THE INVENTION

1. Field of the Invention

The present invention relates to a massage member for neck. In particular, the present invention relates to a massage member having a neck receiving area formed by two groups of protrusions formed on an outer periphery of the massage member.

2. Description of the Related Art

One would feel tired through hard work or repeated movements. The body would feel sore in some portions (e.g., the neck and the shoulder) and requires massage. A typical massage member of the simplest structure includes a rod having a plurality of knurls or protuberances on an end thereof. By means of hitting the end of the massage member at the sore portion of the body, the sore is relieved, as the blood circulation is improved. Some doctors also recommend use of the massage member to proceed with medical massage to heal a patient that has a stroke or muscular injury so as to improve the circulation and to stimulate the body. In some cases, the massage member is used as a tool for consuming calorie for the purpose of losing weight. However, such a massage member can only be used in a local area for point massage. Further, it is labor-intensive to the user for proceeding with massage.

### SUMMARY OF THE INVENTION

An object of the present invention is to provide a massage member having a neck receiving area formed by two groups of protrusions formed on an outer periphery of the massage member.

A massage member in accordance with the present invention comprises an elongated member having an outer periphery and made of soft material. Two groups of protrusions are formed on the outer periphery of the elongated member and spaced apart by a portion of a length of the elongated member. Each group of protrusions includes a plurality of rows of protrusions. Each row of protrusions is annularly arranged on the outer periphery of the elongated member.

In each group of protrusions, each of one row of protrusions has a radial length that is shorter than that of each of another row of protrusions that is more far away from the portion of the length of the elongated member. The groups of protrusions together define a neck receiving area for receiving and massaging a neck of a body.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a massage member in accordance with the present invention.

FIG. 2 is a side view of the massage member in accordance with the present invention.

FIG. 3 is a schematic end view illustrating use of the massage member in accordance with the present invention.

FIG. 4 is a schematic side view illustrating another use of the massage member in accordance with the present invention.

### DETAILED DESCRIPTION OF THE PREFERRED EMBODIMENT

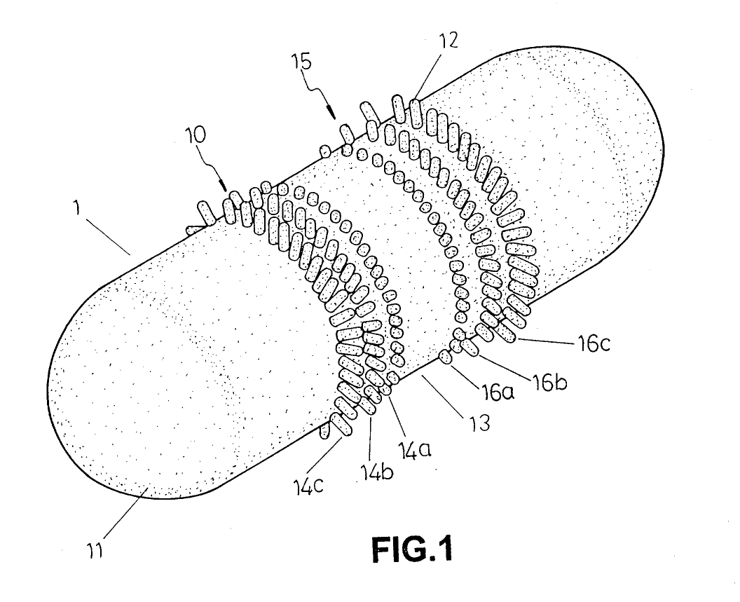

Referring to FIG. 1, a massage member in accordance with the present invention is designated by “1” and is an elongated member 11 made of soft material. Water, air, or stuffing material is fitted into an interior of the elongated member 11 so as to provide the elongated member 11 with resilience.

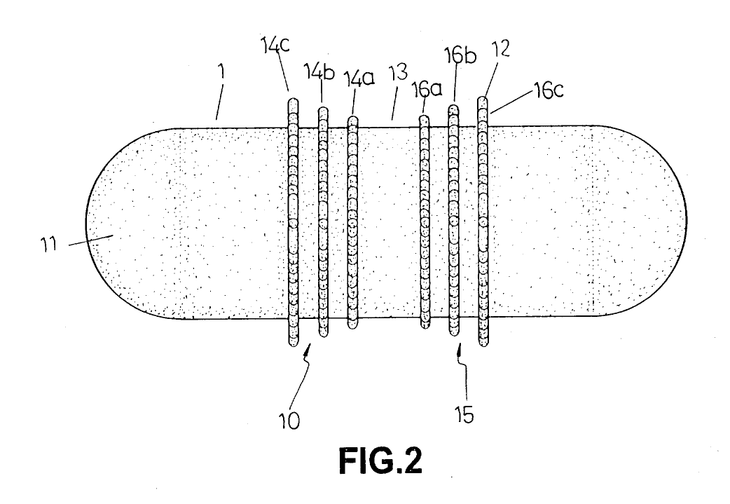

Referring to FIG. 1 and further to FIG. 2, two groups of protrusions 10 and 15 are formed on an outer periphery of the elongated member 11 and spaced apart by a portion (e.g., the central portion) of a length of the elongated member 11.

Each group of protrusions 10, 15 including a plurality of rows of protrusions 14a, 14b, 14c, 16a, 16b, 16c. Each row of protrusions 14a, 14b, 14c, 16a, 16b, 16c is annularly arranged on the outer periphery of the elongated member 11.

In group 10, each of one row of protrusions (e.g., protrusion 12 on row 14a) has a radial length that is shorter than that of each of another row of protrusions (e.g., protrusion 12 on row 14b) that is more far away from the central portion of the length of the elongated member 11. Similarly, in group 15, each of one row of protrusions (e.g., protrusion 12 on row 16b) has a radial length that is shorter than that of each of another row of protrusions (e.g., protrusion 12 on row 16c) that is more far away from the central portion of the length of the elongated member 11.

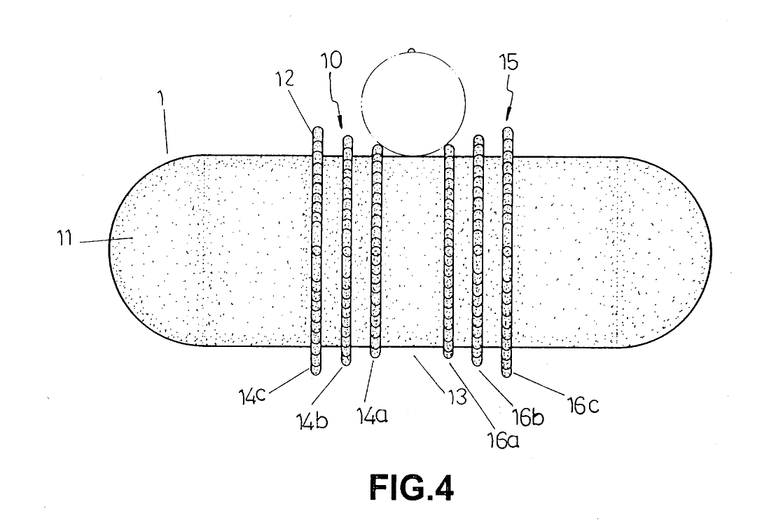

Thus, the groups of protrusions 10 and 15 together define a neck receiving area 13 for receiving and massaging a neck of a body, best shown in FIG. 4. Preferably, the groups of protrusions 10 and 15 are symmetrically arranged with respect to the central portion of the length of the elongated member 11. It is noted that the neck of the body can be well supported and massaged even if the user's neck moves during sleeping or resting, as the neck receiving area 13 is wide enough. The blood circulation of the body can be improved.

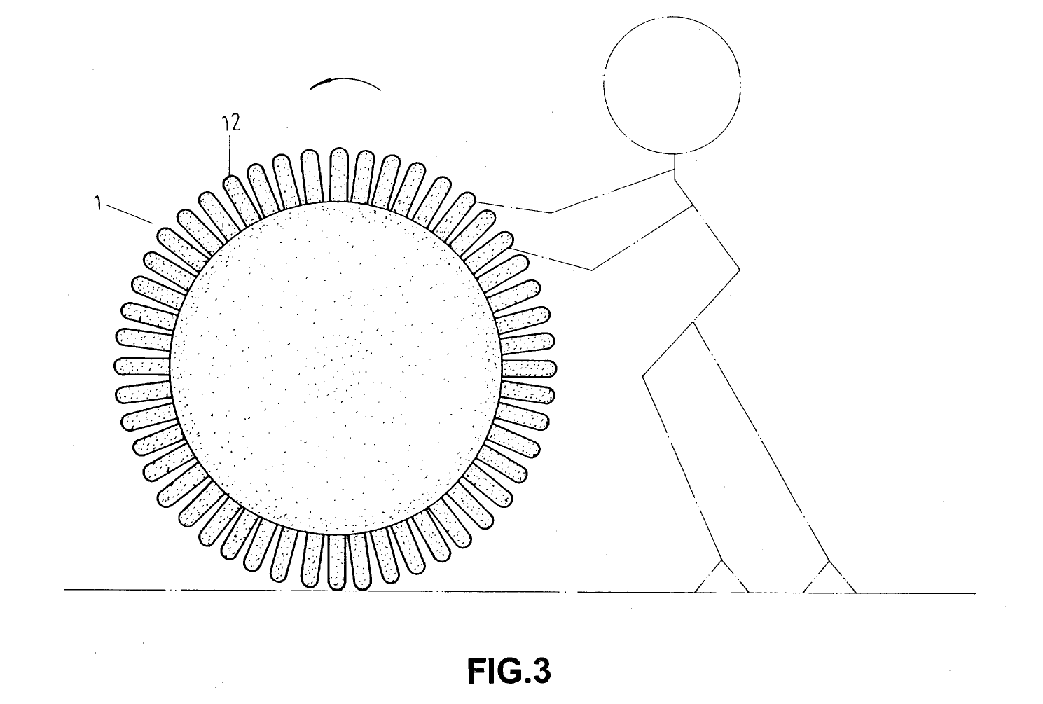

FIG. 3 illustrates another use of the massage member 1 in accordance with the present invention. The user's hand is massaged when the user rolls the elongated member 11. Thus, the massage member 1 can be used as a good rehabilitating device; namely, the massage member 1 provides an entertainment effect while providing the rehabilitating function.

Although the invention has been explained in relation to its preferred embodiment, it is to be understood that many other possible modifications and variations can be made without departing from the scope of the invention as hereinafter claimed.

What is claimed is:

1. A massage member comprising an elongated member having an outer periphery, said elongated member being made of soft material, two groups of protrusions being formed on said outer periphery of said elongated member and spaced apart by a portion of a length of said elongated member, each said group of protrusions including a plurality of rows of protrusions, each said row of protrusions being annularly arranged on said outer periphery of said elongated member, wherein in each said group of protrusions, each of one said row of protrusions has a radial length that is shorter than that of each of another said row of protrusions that is more far away from said portion of said length of said elongated member, and wherein said groups of protrusions together define a neck receiving area for receiving and massaging a neck of a body.

2. The massage member as claimed in claim 1, wherein said groups of protrusions are symmetrically arranged with respect to said portion of said length of said elongated member.

3. The massage member as claimed in claim 1, wherein said portion of said length of said elongated member is a central portion of said length of said elongated member.
